(19) United States
(12) Patent Application Publication
(10) Pub. No.: US 2011/0100939 A1
(43) Pub. Date: May 5, 2011

(54) MODULAR HANGING RACK

(76) Inventor: John Friesch, Whitefish Bay, WI (US)

(21) Appl. No.: 12/940,836

(22) Filed: Nov. 5, 2010

Related U.S. Application Data
(60) Provisional application No. 61/258,387, filed on Nov. 5, 2009.

(51) Int. Cl. A47F 7/00; F16M 13/00; F16M 13/02; A47F 5/00; A47F 5/08

(52) U.S. Cl. 211/85.7; 248/309.1; 248/224.8; 211/86.01; 211/89.01

(57) ABSTRACT

A bat hanging device that can be securely and selectively connected to a chain link fence is disclosed. A modular rack into which the bat hanging device may be securely and selectively inserted is also disclosed.

### CROSS-REFERENCE TO RELATED APPLICATION

This application claims priority under 35 U.S.C. §119(e) to U.S. Provisional Application Ser. No. 61/258,387, filed Nov. 5, 2009 and entitled “Modular Hanging Rack”, the contents of which are hereby incorporated by reference in their entirety.

### BACKGROUND OF THE INVENTION

### Field of the Invention

The present invention relates to a modular hanging rack, and specifically, to a selectively expandable hanging rack that may be configured to retain a variety of different objects, and in particular for retaining sporting equipment such as baseball bats, tennis racquets, etc. A preferred embodiment of the modular hanging rack features a hanging portion that may be removed from the rack and used separately, particularly by hanging on a chain-link fence.

### BRIEF DESCRIPTION OF THE DRAWINGS

Preferred exemplary embodiments of the invention are illustrated in the accompanying drawings, in which like reference numerals represent like parts throughout, and in which:

FIG. 1 is a perspective view of a device of the present invention shown in use mounted to a chain link fence and bearing a baseball bat;

FIG. 2 is a perspective view of the device shown in FIG. 1, shown apart from the fence and bat;

FIG. 3 is a front view of the device shown in FIG. 1, shown mounted to a chain link fence such that a portion of the device obscures the portion of the fence shown in phantom;

FIG. 4 is a rear view of the device shown in FIG. 1, also showing the spring clips removed from the device;

FIG. 5 is a side view of the device shown in FIG. 1, now showing the spring clips positioned on the device;

FIG. 6 is a rear view of the device shown in FIG. 1 illustrating the installation of the device, with a first insertion orientation shown in phantom, and a second retaining orientation shown in solid line;

FIG. 7 is a cross-sectional rear view of the device shown in FIG. 1 taken from line 7-7 of FIG. 5, which shows the device in the second retaining orientation and illustrates the spring clips in their natural position in solid lines and the spring clips in a retention position in phantom lines;

FIG. 8 is a perspective view of two of the devices shown in FIG. 1 in conjunction with a modular rack designed to hold the devices;

FIG. 9 is a perspective view of the modular rack shown in FIG. 8, illustrating different embodiments of the hanging portion of the device; and

FIG. 10 is a perspective view of the modular rack shown in FIG. 8, taken from the back of the rack, and showing yet another embodiment in which the modular rack is provided with a shelf.

### DETAILED DESCRIPTION

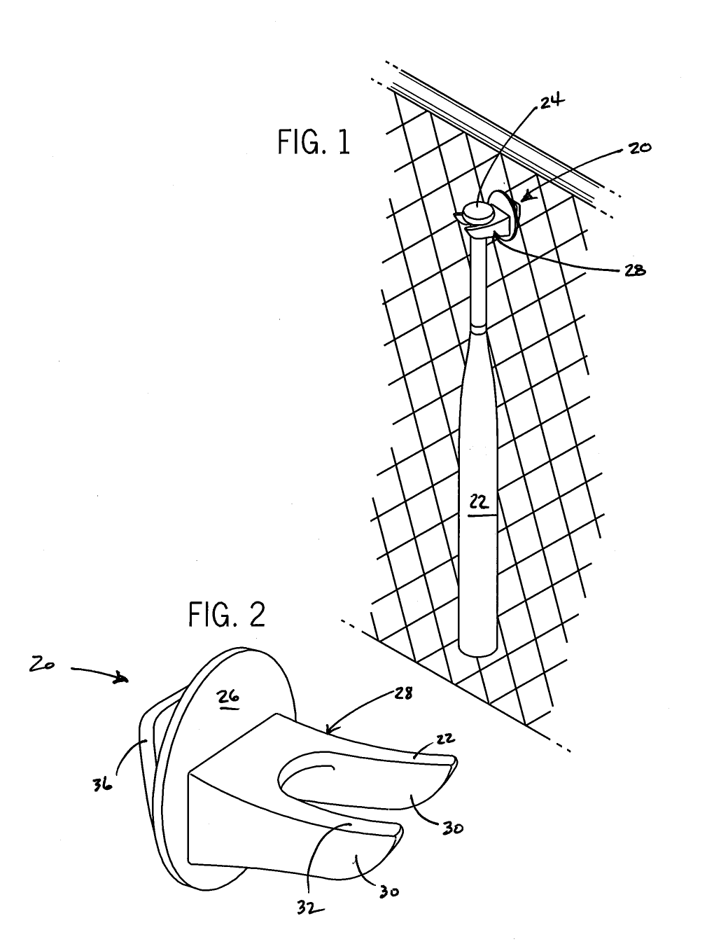

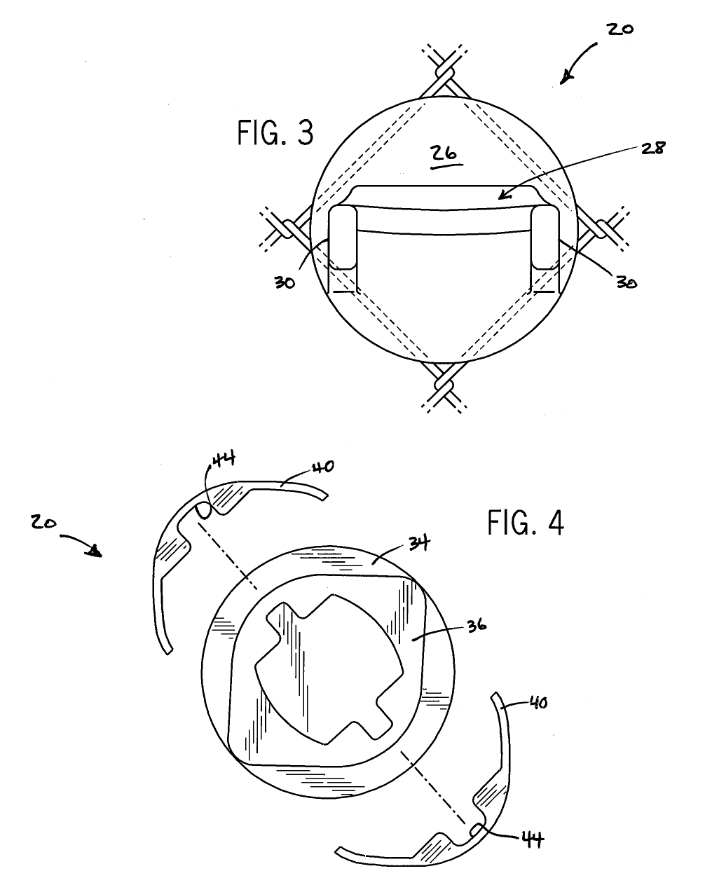

Referring to the drawings, and initially to FIG. 1, an embodiment of the present invention, a bat hanging device 20, is shown in use on a chain-link fence, suspending a bat 22 by its knob 24. Device 20 has a substantially circular front portion 26 bearing a hanger 28 designed to support knob 24 of bat 22. Hanger 28 is comprised of a pair of arms 30 having a top surface 32. Top surface 32 may be curved to better retain bat 22.

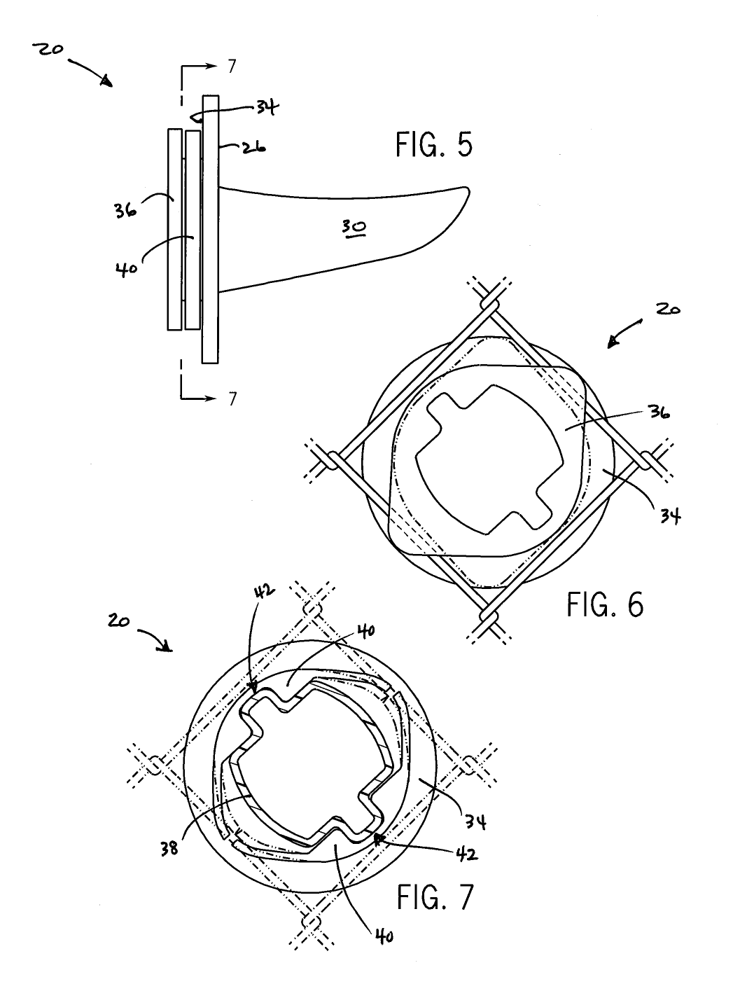

Turning to FIG. 4, the rear portion 34 of device 20 can be the opposite side of circular front portion 26, and a cam member 36 is connected to rear portion 34. As seen in FIG. 5, cam member 36 is spaced apart from rear portion 34 by way of a connection stem 38. Connection stem 38 is best seen in FIG. 7, which is a cross-sectional view of FIG. 5. Cam member 36 is spaced apart from rear portion 34 at a distance that allows installation of device 20 in an aperture of a chain link fence, as will be further discussed below.

Connection stem 38 can be shaped to retain a pair of spring clips 40. Spring clips 40 are shown apart from connection stem 38 in FIG. 4, while FIGS. 5 and 7 show clips 40 in communication with connection stem 38. As seen in FIG. 7, connection stem 38 has a pair of projections 42 shaped to provide a snapping connection with corresponding notches 44 of clips 40.

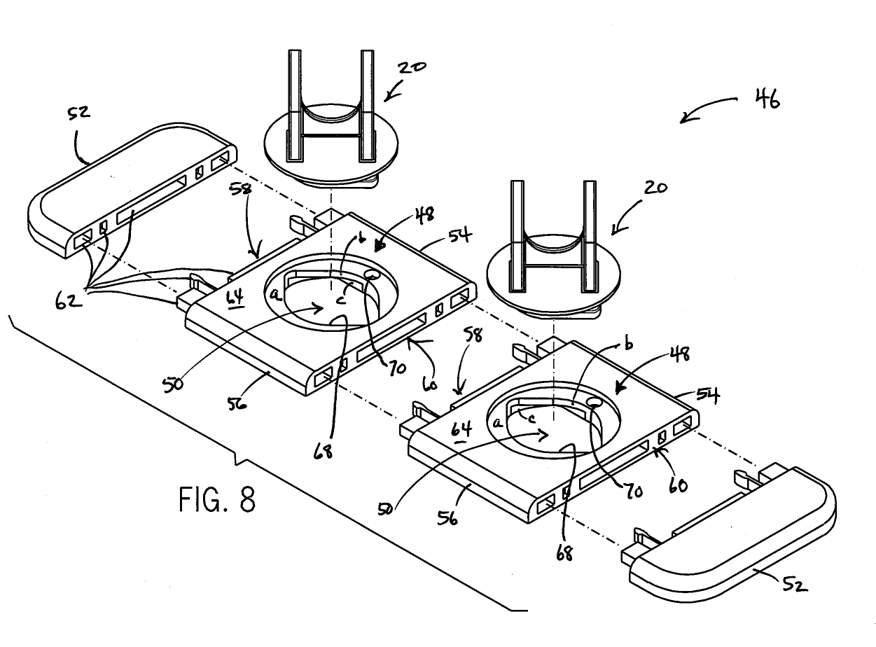

Turning now to FIG. 8, bat hanging device 20 is shown in combination with a rack system 46 for retaining a plurality of devices 20. Rack system 46 comprises one or more base portions 48 that are selectively coupleable to one another. Each base 48 includes a centrally located aperture 50 for receiving a device 20. Rack system 46 can also be provided with end caps 52 to be placed on opposite ends of the plurality of bases 48. Rack system 46 is thereby constructed to allow a plurality of bases 48 to be coupled to one another, providing a rack that is selectively configurable to accommodate as many articles as desired.

Each base 48 is substantially rectangular in shape, though other shapes may be used, and includes parallel top and bottom portions 54, 56 and first and second sides 58, 60. Each of sides 58, 60 bears a portion of a latch assembly 62 that allows a first side 58 of a first base 48a to be positively latched to a second side 60 of a second base 48b. Similarly, each end cap 52 bears a portion of latch assembly 62 such that end caps 52 may be positioned on opposite ends of one or more connected bases 48 to provide a finished appearance to the modular rack.

Each portion of latch assembly 62 may be integrally formed with its corresponding base 48, and, though a particular latching structure is shown in FIG. 8, it should be understood that any number of alternative latching arrangements may be utilized without departing from the spirit of the invention. Likewise, the proposed connection between the latching portions of a base 48 and end caps 52 can be modified as dictated by manufacturing or other concerns, and all such modifications should be considered within the scope of the present invention.

Base 48 receives and retains device 20 by way of aperture 50, which is sized and shaped to receive cam member 36 and connection stem 38 so that front portion 26 is flush with the front surface 64 of base 48. As seen in FIG. 8, aperture 50 is defined by an integrally formed contoured portion 68, which further defines an aperture 50. Aperture 50 can therefore be said to define a first circular portion 50a, a second cam-shaped portion 50b, and a third locking portion 50c. Note that second cam-shaped portion 50b and third locking portion 50c form, at some points around the circumference of aperture 50, a solid entity into which a hole 70 may be formed for attaching base 48 to a wall or other surface.

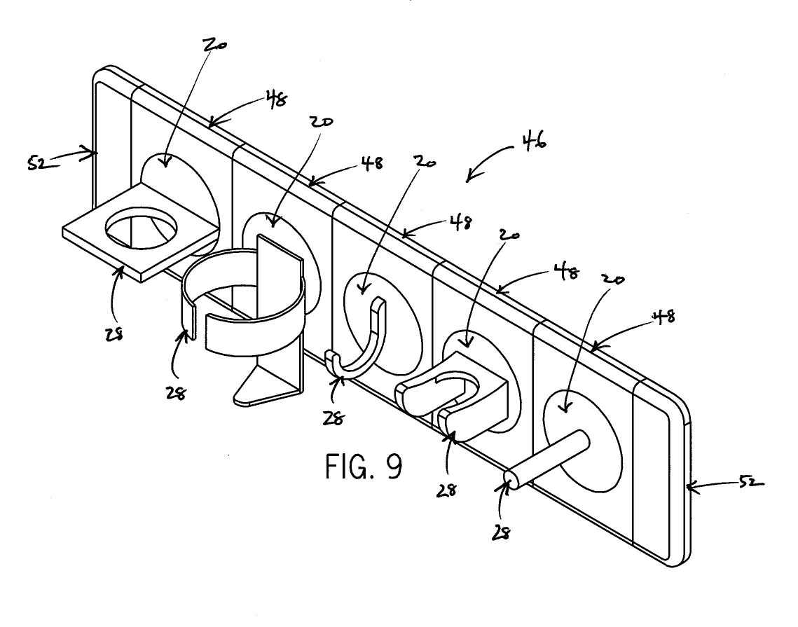

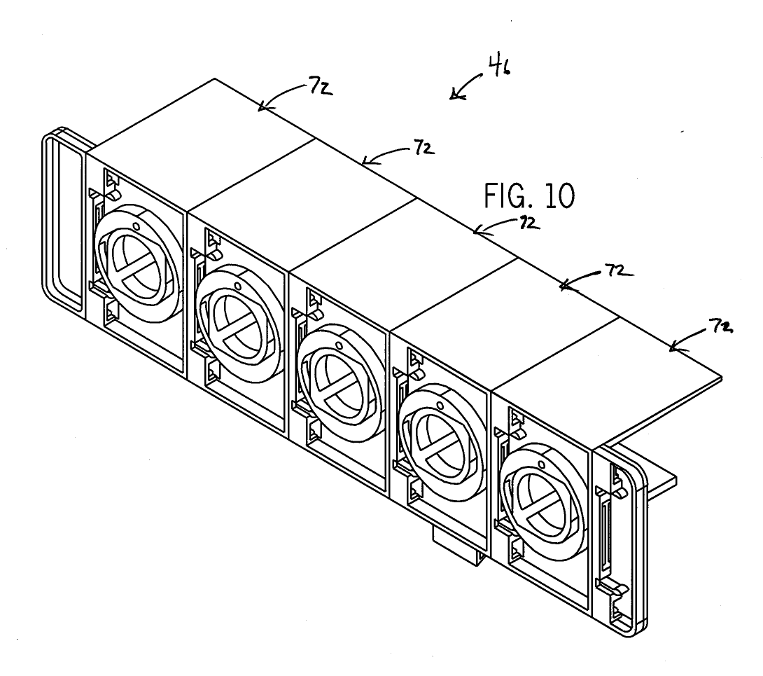

Referring to FIGS. 9 and 10, it can be seen that several embodiments of hanger 28 are contemplated, and different embodiments of base 20 are likewise contemplated. In FIG. 9, hanger elements include a ball holder, cup holder, hook, bat holder, and peg, but the embodiments shown should in no way be considered limiting, since any number of hanging structures could be used. In FIG. 10, base 48 is supplied with a shelf structure 72 extending from top portion 54 such that a series of bases having a series of shelves 72 would create a substantially continuous shelf the length of the series of bases.

In use, device 20 may be inserted into base 48 by first aligning cam member 36 with cam-shaped portion 50b, inserting cam member 36 through cam-shaped portion 50b into third locking portion 50c, and turning device 20 to lock cam member 36 behind cam-shaped portion 50b.

Device 20 can thus be removed from base 48 and transported to another location. For example, a user might have two racks in his or her home, and move device 20 from one home location to a second home location. Or, if a user has a friend or relative with a rack in his or her home, the user might wish to move device 20 from the home rack to the other user's rack. Users may also trade inserts as the need arises, or swap out inserts that are no longer used for ones that may be more useful. For example, a bat rack in one's mud room may be valuable during baseball season, but coat hooks may be more valuable during the winter season. In this example, the user may wish to move inserts supplied with a bat hook to a second rack in a storage location, and replace them with inserts supplied with a coat hook.

Of course, device 20 is also designed to be installed on a chain link fence. Chain link fences come in a number of sizes, but the most common opening sizes are 2″ or 2.25″. Further, the standards for chain link fences, as promulgated by ASTM International, requires a minimum of 2″ mesh for use in ballfields and other sports facilities. Cam member 36, which is approximately 2.25″ as measured across its greatest length, fits within the most common mesh openings. As a result, cam member 36 is able to be used to individually couple device 20 to a chain link fence.

In this operation, device 20 is aligned with an opening in a chain link fence such that cam member 36 may pass through the opening, and is inserted through the opening. FIG. 6 shows the insertion alignment in phantom lines. Device 20 is again turned, now to lock cam member 36 behind the wire that comprises the fence, which is shown in solid lines in FIG. 6.

Further, in order to provide device 20 with a firmer grip when attached to a fence, spring clips 40 may be employed. As seen in solid lines in FIG. 7, spring clips 40 are sized somewhat larger than the distance between opposing wires. When twisted into place between opposing wires, clips 40 are forced into an unnatural position, thus providing resistance against the fence and improved retention.

Clips 40 are particularly useful when a fence is no longer taut, as is the case in some ballfields, for retaining device 20 on the fence. Similarly, where a fence is somewhat saggy, device 20 can be expected to hang down and release bat 22. It has been found that providing some upward curvature of the arms 30, as seen in FIG. 5, better cradles knob 24 and improves retention of bat 22 on device 20, even on substandard fences. However, clips 40 are not required and curvature can vary significantly without departing from the invention. Alternately, a metal spring or other resistance object could be used, and a hanger portion that positively grasps a bat, such as a Velcro® fabric strip, could be employed.

Accordingly, a user may transport device 20 to another location such as a baseball field, softball field, or tennis court where there is typically a chain link fence, and attach device 20 to the chain link fence. The articles are thus protected from unwanted wear and tear that often occurs when such articles are merely placed on the ground or elsewhere when they are not in use.

The embodiments described herein explain the best known mode of practicing the invention and will enable others skilled in the art to utilize the invention, but should not be considered limiting. Rather, it should be understood that the invention is not limited to the details of construction and arrangements of the components set forth herein, but is capable of other embodiments and of being practiced or carried out in various ways, and all such modifications and variations are within the scope of the claims set forth below. Further, various elements or features discussed or shown herein may be combined in ways other than those specifically mentioned, and all such combinations are likewise within the scope of the invention.

I claim:

1. A device comprising:
a support having a front side and a rear side;
a hanger coupled to the front side of the support; and
a cam coupled to the rear side of the support.

2. The device of claim 1, wherein the cam is coupled to the rear side by way of a connection stem.

3. The device of claim 2, further comprising a pair of spring clips coupled to the connection stem.

4. The device of claim 1, wherein the hanger is shaped to suspend the knob of a baseball bat.

5. The device of claim 4, wherein the hanger has a pair of arms that curve upwardly to retain the knob of a baseball bat.

6. The device of claim 1, wherein the cam is sized to fit into an opening of a standard chain-link fence and, when turned clockwise or counterclockwise, is retained by the mesh of the chain-link fence.

7. A modular hanging rack comprising:
at least one base defining an aperture; and
a device adapted for selective insertion through and retention within the aperture, wherein the device includes a front side bearing a hanging means, and wherein said hanging means is configured for suspending an object.

8. The modular hanging rack of claim 7, wherein the device is configured to be selectively removable from the base for mounting at another location.

9. The modular hanging rack of claim 8, wherein the other location is a chain-link fence.

10. The modular hanging rack of claim 7, wherein the aperture defines a cam-receiving means and the device includes a cam adapted for selective engagement with the cam-receiving means of the aperture to thereby secure the insert to the base.

11. The modular hanging rack of claim 7, wherein the base has a first side and a second side, each of which bears a connection portion for connecting a side of a base with another item bearing a cooperating connection portion.

12. The modular hanging rack of claim 11, wherein the other item is a second base.

13. The modular hanging rack of claim 11, wherein the other item is an end cap.
